(19) United States
(12) Patent Application Publication
(10) Pub. No.: US 2015/0111576 A1
(43) Pub. Date: Apr. 23, 2015

(54) Pico Cell-Selection/Handover for TDM EICIC Heterogenous Networks

(71) Applicants: Klaus Ingemann Pedersen, Aalborg (DK); Beatriz Soret, Aalborg (DK)

(72) Inventors: Klaus Ingemann Pedersen, Aalborg (DK); Beatriz Soret, Aalborg (DK)

(73) Assignee: Nokia Solutions and Networks Oy, Espoo (FI)

(21) Appl. No.: 14/384,421

(22) PCT Filed: Mar. 12, 2012
(86) PCT No.: PCT/EP2012/054289

§ 371 Date: Sep. 11, 2014

(51) Int. Cl. H04W 36/26

(52) U.S. Cl. CPC H04W 36/26
USPC 455/436

(57) ABSTRACT

It is checked if a first CRE from a first cell is larger than 0; and if a second CRE from a second cell is larger than 0. If both the first and the second CRE are larger than 0, a first modified CRE is set based on the first CRE and a second modified CRE is set based on the second CRE. If the first CRE and/or the second CRE is equal to 0, the first modified CRE is set to the first CRE and the second modified CRE is set to the second CRE. One of the first and second cell is selected for cell selection and/or handover based on a comparison of a sum of a signal strength indicator from the first cell and the first modified CRE and a sum of a signal strength indicator from the second cell and the second modified CRE.

### FIELD OF THE INVENTION

The present invention relates to an apparatus, a method, a system, and a computer program product related to improving the handover and/or cell selection. More particularly, the present invention relates to an apparatus, a method, a system, and a computer program product for improved handover and/or cell selection in heterogeneous networks.

### BACKGROUND OF THE INVENTION

### Abbreviations

3GPP 3rd generation partnership project

### ABS Almost Blank Subframe

### CRE Cell Range Extension

eICIC enhanced Inter-Cell Interference Coordination

### eNB Evolved Node B

### LTE Long Term Evolution

### PUE Pico User Equipment

### RSRP Reference Signal Received Power

### RSRQ Reference Signal Received Quality

### TDM Time Domain

TS Technical specification

Cell-selection/handover methods in heterogeneous networks (HetNet) with co-channel deployment of macro-eNBs and pico-eNBs, in particular with Time Domain (TDM) enhanced Inter-Cell Interference-Coordination (eICIC) may be improved.

In conventional macro-cell networks, UE cell selection/handover is typically based on UE measurements of Reference Signal Received Power (RSRP). However, applying this criterion to HetNets leads to a downlink imbalance problem: the coverage of the macro-cell is much larger than that of the pico-cell due to the difference in transmission power between both layers. However, the RSRP-based cell selection can be adapted to HetNets by adding a positive bias (Cell Range Extension CRE) to the received RSRP value in order to balance the load macro-pico. Thus, RSRP+CRE-based cell selection makes the UE to select the cell with highest RSRP+CRE value, where CRE is equal to zero for macro-cells and positive for pico-cells.

As shown in the baseline scenario in FIG. 1, the footprint (coverage area) of the pico-cell is expanded by the application of the CRE offset. To protect a victim pico UEs (PUEs=a UE served by the pico eNB) in the extended area from severe interference from macro layer, the macro eNB is prevented from transmitting on certain subframes, called Almost Blank Subframes (ABS).

### SUMMARY OF THE INVENTION

It is an object of the present invention to improve the prior art.

According to a first aspect of the invention, there is provided an apparatus, comprising first cell range extension checking means adapted to check if a first received cell range extension received from a first cell is larger than 0; second cell range extension checking means adapted to check if a second received cell range extension received from a second cell is larger than 0, wherein the second cell is different from the first cell; setting means adapted to set, if both the first received cell range extension and the second received cell range extension are larger than 0, a first modified cell range extension based on the first received cell range extension and a second modified cell range extension based on the second received cell range extension, wherein for at least one combination of values of the first and second received cell range extensions at least one of the first and second modified cell range extensions is different from the respective received cell range extension, and to set, if at least one of the first received cell range extension and the second received cell range extension is equal to 0, the first modified cell range extension equal to the first received modified cell range extension and the second modified cell range extension equal to the second received cell range extension; selecting means adapted to select one of the first cell and the second cell for cell selection and/or handover based on a comparison of a sum of a first signal strength indicator from the first cell and the first modified cell range extension and a sum of a second signal strength indicator from the second cell and the second modified cell range extension.

The apparatus may further comprise attaching means adapted to attach the apparatus to the cell selected by the selecting means.

In the apparatus, the first and second signal strength indicators may be respective reference signal received powers or the first and second signal strength indicators may be respective reference signal received qualities.

In the apparatus, the setting means may be adapted to set, if both the first received cell range extension and the second received cell range extension are larger than 0, the first modified cell range extension and the second modified cell range extension such that an absolute value of a difference between the first modified cell range extension and the second modified cell range extension is not larger than a threshold.

The apparatus may further comprise comparing means adapted to compare which of the first received cell range extension and the second received cell range extension is the larger one; and the setting means may be adapted to set, if the first received cell range extension is not smaller than the second received cell range extension, the first modified cell range extension equal to the minimum among the first received cell range extension and a sum of the second received cell range extension and the threshold, and to set, if the first received cell range extension is smaller than the second received cell range extension, the second modified cell range extension equal to the minimum among the second received cell range extension and a sum of the first received cell range extension and the threshold.

In the apparatus, the threshold may be 0.

In the apparatus, the setting means may be adapted to set, if both the first received cell range extension and the second received cell range extension are larger than 0, the first modified cell range extension equal to a the first received cell range extension multiplied by a factor and the second modified cell range extension equal to the second received cell range extension multiplied by the factor, wherein the factor is less than 1.

According to a second aspect of the invention, there is provided an apparatus, comprising first cell range extension checking processor adapted to check if a first received cell range extension received from a first cell is larger than 0; second cell range extension checking processor adapted to check if a second received cell range extension received from a second cell is larger than 0, wherein the second cell is different from the first cell; setting processor adapted to set, if both the first received cell range extension and the second received cell range extension are larger than 0, a first modified cell range extension based on the first received cell range extension and a second modified cell range extension based on the second received cell range extension, wherein for at least one combination of values of the first and second received cell range extensions at least one of the first and second modified cell range extensions is different from the respective received cell range extension, and to set, if at least one of the first received cell range extension and the second received cell range extension is equal to 0, the first modified cell range extension equal to the first received modified cell range extension and the second modified cell range extension equal to the second received cell range extension; selecting processor adapted to select one of the first cell and the second cell for cell selection and/or handover based on a comparison of a sum of a first signal strength indicator from the first cell and the first modified cell range extension and a sum of a second signal strength indicator from the second cell and the second modified cell range extension.

The apparatus may further comprise attaching processor adapted to attach the apparatus to the cell selected by the selecting processor.

In the apparatus, the first and second signal strength indicators may be respective reference signal received powers or the first and second signal strength indicators may be respective reference signal received qualities.

In the apparatus, the setting processor may be adapted to set, if both the first received cell range extension and the second received cell range extension are larger than 0, the first modified cell range extension and the second modified cell range extension such that an absolute value of a difference between the first modified cell range extension and the second modified cell range extension is not larger than a threshold.

The apparatus may further comprise comparing processor adapted to compare which of the first received cell range extension and the second received cell range extension is the larger one; and the setting processor may be adapted to set, if the first received cell range extension is not smaller than the second received cell range extension, the first modified cell range extension equal to the minimum among the first received cell range extension and a sum of the second received cell range extension and the threshold, and to set, if the first received cell range extension is smaller than the second received cell range extension, the second modified cell range extension equal to the minimum among the second received cell range extension and a sum of the first received cell range extension and the threshold.

In the apparatus, the threshold may be 0.

In the apparatus, the setting processor may be adapted to set, if both the first received cell range extension and the second received cell range extension are larger than 0, the first modified cell range extension equal to a the first received cell range extension multiplied by a factor and the second modified cell range extension equal to the second received cell range extension multiplied by the factor, wherein the factor is less than 1.

According to a third aspect of the invention, there is provided a user equipment comprising an apparatus according to any of the first and second aspects.

According to a fourth aspect of the invention, there is provided a system, comprising an apparatus according to any of the first and second aspects; a first base station with the first cell; a second base station with the second cell; wherein the first base station transmits the first received cell range extension in the first cell and the second base station transmits the second received cell range extension in the second cell.

According to a fourth aspect of the invention, there is provided a method, comprising checking if a first received cell range extension received from a first cell is larger than 0; checking if a second received cell range extension received from a second cell is larger than 0, wherein the second cell is different from the first cell; setting, if both the first received cell range extension and the second received cell range extension are larger than 0, a first modified cell range extension based on the first received cell range extension and a second modified cell range extension based on the second received cell range extension, wherein for at least one combination of values of the first and second received cell range extensions at least one of the first and second modified cell range extensions is different from the respective received cell range extension, setting, if at least one of the first received cell range extension and the second received cell range extension is equal to 0, the first modified cell range extension equal to the first received modified cell range extension and the second modified cell range extension equal to the second received cell range extension; and selecting one of the first cell and the second cell for cell selection and/or handover based on a comparison of a sum of a first signal strength indicator from the first cell and the first modified cell range extension and a sum of a second signal strength indicator from the second cell and the second modified cell range extension.

The method may be a method of cell selection and/or handover.

The method may further comprise attaching an apparatus performing the method to the selected cell.

In the method, the first and second signal strength indicators may be respective reference signal received powers or the first and second signal strength indicators may be respective reference signal received qualities.

In the method, if both the first received cell range extension and the second received cell range extension are larger than 0, the first modified cell range extension and the second modified cell range extension may be set such that an absolute value of a difference between the first modified cell range extension and the second modified cell range extension is not larger than a threshold.

The method may further comprise comparing which of the first received cell range extension and the second received cell range extension is the larger one; and, if the first received cell range extension is not smaller than the second received cell range extension, the first modified cell range extension may be set equal to the minimum among the first received cell range extension and a sum of the second received cell range extension and the threshold, and, if the first received cell range extension is smaller than the second received cell range extension, the second modified cell range extension may be set equal to the minimum among the second received cell range extension and a sum of the first received cell range extension and the threshold.

In the method, the threshold may be 0.

In the method, if both the first received cell range extension and the second received cell range extension are larger than 0, the first modified cell range extension may be set equal to a the first received cell range extension multiplied by a factor and the second modified cell range extension may be set equal to the second received cell range extension multiplied by the factor, wherein the factor is less than 1.

According to a fifth aspect of the invention, there is provided a computer program product including a program comprising software code portions being arranged, when run on a processor of an apparatus, to perform the method according to the fourth aspect.

The computer program product may comprise a computer-readable medium on which the software code portions are stored, and/or the computer program product program may be directly loadable into a memory of the processor.

According to embodiments of the invention, at least the following advantages are achieved:

In an area where several cells with different (positive) CRE offsets (e.g. pico cells) may serve a UE, the CRE offsets used for cell selection/handover may be based on the received CREs but modified such that interference from other cells different from the serving one does not become too severe.

E.g., a difference between these modified CRE offsets may be limited to be not more than a threshold TH. A UE in this area is served by the NodeB with the strongest signal+modified CRE. Thus, interference impact is reduced and at the same time the load balance between eNBs is preserved. On the other hand, a preference of the pico NodeB (NodeB with positive CRE) over a NodeB of a higher hierarchy level such as a macro NodeB (NodeB with CRE=0) is maintained for the UE.

In other embodiments, the modified CREs may be a fraction of the CREs. Thus, their influence on cell selection/handover is reduced and may not overwhelm the interference reduction required with respect to the non-serving cells.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a heterogeneous network with a single pico eNB;

FIG. 2 shows a heterogeneous network with two pica eNB;

FIG. 3 shows an apparatus according to an embodiment of the invention;

FIG. 4 shows a method according to an embodiment of the invention;

FIG. 5 shows a method according to an embodiment of the invention; and

FIG. 6 shows a method according to an embodiment of the invention.

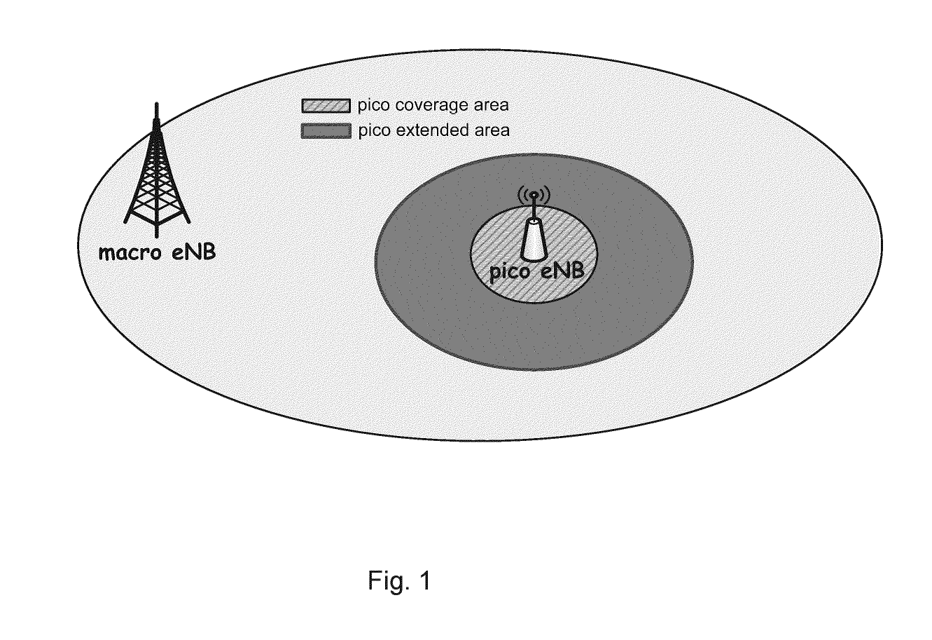

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to 3GPP Rel 10, pico-cells may be configured with a CRE positive offset (bias). Different pico-cells may apply different CRE bias depending on their own capacities and load conditions.

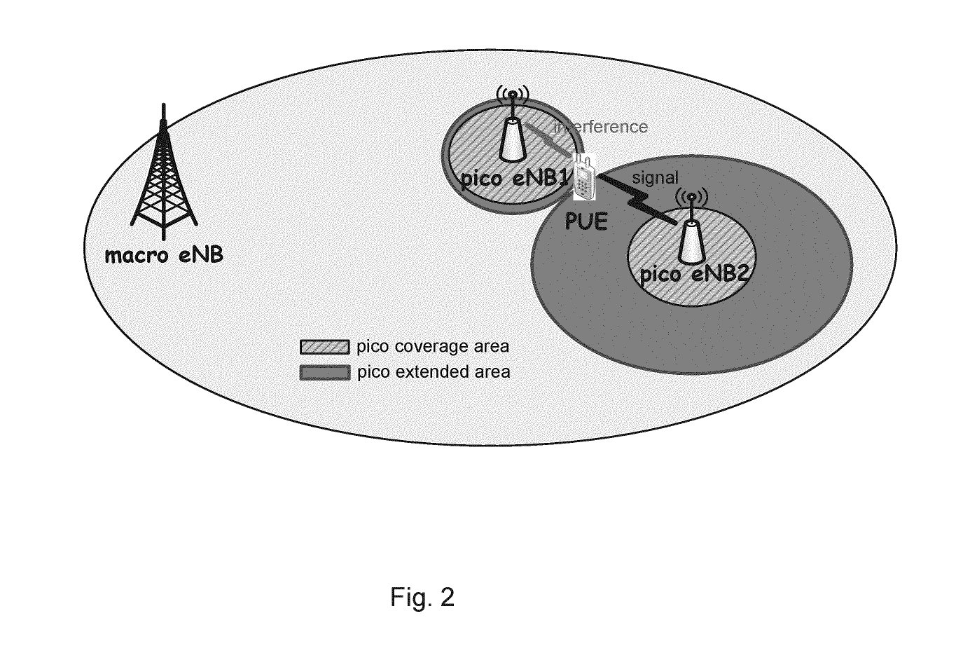

FIG. 2 shows a network comprising a macro eNB and two pico eNBs (eNB1 and eNB2) with differently extended areas, and a PUE. Here, pico eNB1 is applying a small CRE offset, whereas pica eNB2 has been configured with a high value of CRE offset, leading to a much larger extended area. The PUE gets measures of the RSRP of the two cells, being RSRP eNB1>RSRPeNB2. Without CRE offset, the PUE would connect to pico eNB1. However, due to the imbalanced CRE offset between both pico cells, the PUE connects to pico eNB2. TDM eICIC techniques (with the transmission of ABS) protect the PUE in the range extended area from macro interference. However, in the case of the PUE in FIG. 2, the PUE is not protected from interference from pico eNB1 because pico cells are not muted (no ABS). Thus, the PUE will suffer interference from pico eNB1 and low signal strength from the serving pico eNB2 during the whole connection (if not moved to another location). This interference becomes more severe the more the difference between CRE offsets.

In order to overcome this problem, according to embodiments of the invention, the RSRP+CRE-based cell selection/handover for the case of pico-cells is adapted. In detail, the CRE offsets used in the cell-selection/handover may be modified based on the received CREs when the two candidates (in case of handover: the serving cell and a candidate for handover) are pico-cells applying positive bias. E.g., the maximum difference CRE_{eNB1}-CRE_{eNB2} may be limited to be at maximum TH. TH may be expressed in dB. Notice that the case TH=0 dB corresponds to the traditional RSRP-based cell selection applied in homogeneous networks.

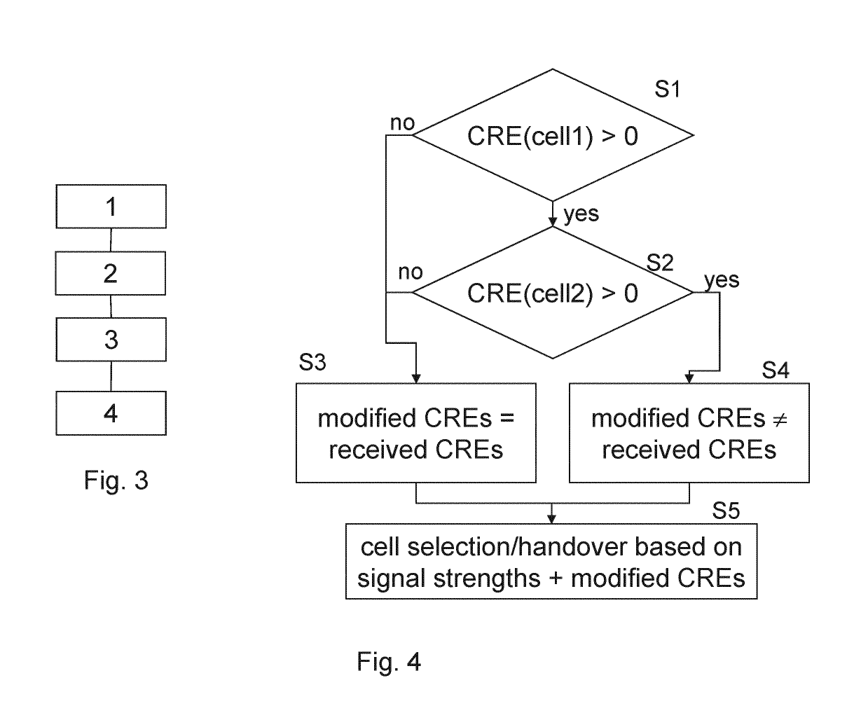

FIG. 3 shows an apparatus according to an embodiment of the invention. The apparatus may be a user equipment. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises first cell range extension checking means 1, second cell range extension checking means 2, modifying means 3, and selecting means 4.

The first and second cell range extension checking means 1 and 2 check if the first and second cell range extensions received from the first and second cell, respectively, are larger than 0 (S1, S2).

If both of them are larger than 0, it is assumed that both cells are pico cells (or other cells with a positive CRE). In this case, first and modified CREs are set by the setting means 3 based on the respective received CREs (S4). For at least one combination of values, at least one of the first and second modified CREs is different from the respective received CRE.

On the other hand, if at least one of the received CREs is equal to 0, the first and second modified CREs are set by the setting means 3 equal to the respective received CREs (S3).

The selecting means 4 selects one of the first and second cells for cell selection/handover based on a sum of a respective received signal strength from these cells and the respective modified CRE (S5). Parameters for signal strength may be e.g. RSRP and/or RSRQ.

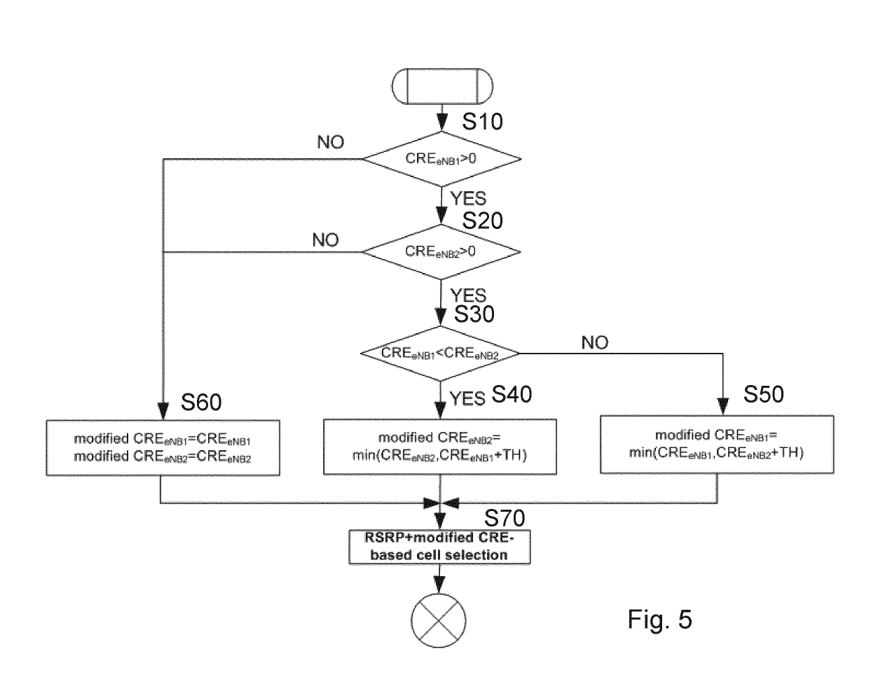

FIG. 5 shows a flow diagram of a particular cell-selection/handover method according to an embodiment of the invention. The modified method may be performed by an apparatus as according to FIG. 3. FIG. 5, shows an exemplary embodiment, according to which an absolute value of a difference between the modified CRE values is limited to a threshold.

According to step S10, it is evaluated if the CRE received from eNodeB1 is larger than 0. If not, i.e. if it is 0 (no in step S10), the CRE offsets are not modified for cell selection/handover, i.e. the modified CRE offsets are the same as the received CRE offset (S60).

Otherwise, if CRE of eNodeB1 is larger than 0 (yes in step S10), according to step S20, it is it is evaluated if the CRE of eNodeb2 is larger than 0. If not, i.e. if it is 0 (no in step S20), the CRE offsets are not modified for cell selection/handover, i.e. the modified CRE offsets are the same as the received CRE offset (S60).

Otherwise, if CRE of eNodeB2 is larger than 0 (yes in step S20), according to step S30 it is evaluated if the received CRE of eNodeB1 is smaller than the received CRE of eNodeB2. If not (no in step S30), according to step S50 the modified CRE offset of eNodeB1 is set to the minimum between the received CRE of eNodeB1 and the received CRE of eNodeB2+TH, wherein TH is a predefined threshold value.

Otherwise, if the received CRE of eNodeB1 is smaller than the received CRE of eNodeB2 (yes in step S30), according to step S40 the modified CRE offset of eNodeB2 is set to the minimum between the received CRE of eNodeB2 and the received CRE of eNodeB1+TH.

The cell selection/handover is performed based on the modified CRE offsets (S70).

Note that the first condition to be fulfilled in order to set the modified CREs different from the received CREs is that the received CREs of both cells are positive (i.e. it is not a cell selection/handover involving a macro cell or a pico-cell with not configured CRE).

Limiting the maximum difference of modified CRE values on which the cell selection/handover is based has the following effect: if the signal from a first pico cell is stronger than that of a second pico cell by more than the threshold TH, the first pico cell will always be selected. Thus, the interference problem is strongly mitigated and at the same time the load balancing function is preserved. On the other hand, if the difference is less than the threshold TH, the selection will be based on RSRP+(modified) CRE, wherein the modified CRE is the same as the unmodified CRE. Thus, the intended preference according to the CRE settings will be preserved in an area where the interference problem is not too severe.

The same effect may be achieved if the difference of the first and second received CREs is evaluated and, if it is larger than the threshold TH, the modified CREs are set such that the larger one of the CREs is equal to the sum of the smaller one of the received CREs plus the threshold TH.

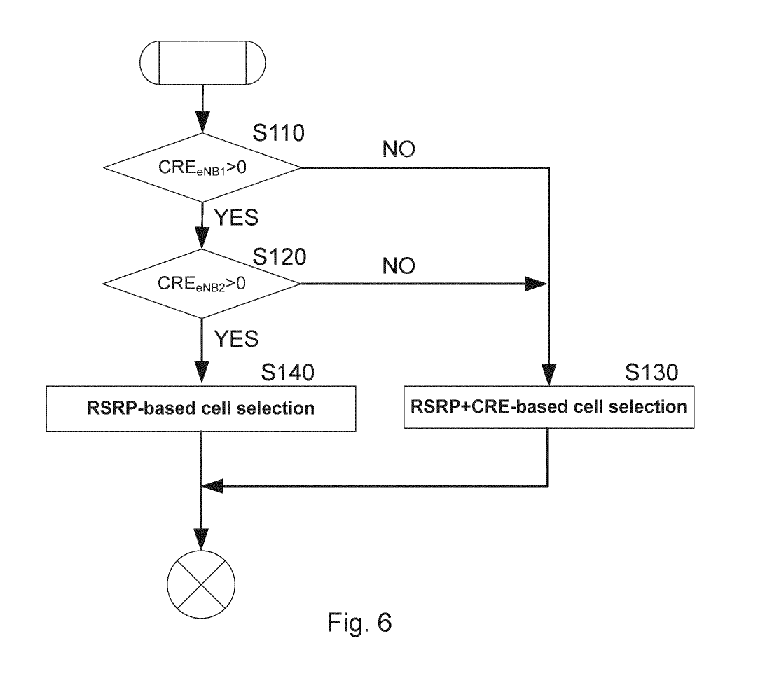

If the threshold TH is set equal to 0, cell selection/handover between two cells with positive CRE will be performed as if no CRE would be considered at all. In a variant of the method of FIG. 5 for this case, both modified CREs are set to 0, which corresponds to performing cell selection/handover based on signal strength (e.g. RSRP) only (see FIG. 6).

Another way to enhance the priority of interference mitigation over the priorities of cell selection expressed by positive CREs is basing the decision on cell selection/handover on modified CREs, which are obtained by multiplying the received CREs with a factor less than 1.

In order to implement embodiments of the invention, 3GPP TS 36.331 should be modified. Conventionally, the measurement event A3 is used in the UE for cell selection. Currently, event A3 is defined as follows (3GPP TS 36.331 v10.3.0):

Event A3 (Neighbour becomes offset better than PCell)

```
The UE shall:
  1> consider the entering condition for this event to be satisfied when
    condition A3-1, as specified below, is fulfilled;
  1> consider the leaving condition for this event to be satisfied when
    condition A3-2, as specified below, is fulfilled;
```

| | |
|---|---|
| NOTE | The cell(s) that triggers the event is on the frequency |
| | indicated in the associated measObject which may be different |
| | from the (primary) frequency used by the PCell. |

Inequality A3-1 (Entering condition)
Mn+Ofn+Ocn−Hys>Mp+Ofp+Ocp+Off
Inequality A3-2 (Leaving condition)
Mn+Ofn+Ocn+Hys<Mp+Ofp+Ocp+Off

The variables in the formula are defined as follows:
Mn is the measurement result of the neighbouring cell, not taking into account any offsets.
Ofn is the frequency specific offset of the frequency of the neighbour cell (i.e. offsetFreq as defined within measObjectEUTRA corresponding to the frequency of the neighbour cell).
Ocn is the cell specific offset of the neighbour cell (i.e. cellIndividualOffset as defined within measObjectEUTRA corresponding to the frequency of the neighbour cell), and set to zero if not configured for the neighbour cell.
Mp is the measurement result of the PCell, not taking into account any offsets.
Ofp is the frequency specific offset of the primary frequency (i.e. offsetFreq as defined within measObjectEUTRA corresponding to the primary frequency).
Ocp is the cell specific offset of the PCell (i.e. cellIndividualOffset as defined within measObjectEUTRA corresponding to the primary frequency), and is set to zero if not configured for the PCell.
Hys is the hysteresis parameter for this event (i.e. hysteresis as defined within reportConfigEUTRA for this event).
Off is the offset parameter for this event (i.e. a3-Offset as defined within reportConfigEUTRA for this event).
Mn, Mp are expressed in dBm in case of RSRP, or in dB in case of RS RQ.
Ofn, Ocn, Ofp, Ocp, Hys, Off are expressed in dB.

Here, Ocn is the CRE of the neighbour cell and Ocp the CRE of the serving cell (PCell). The CRE of each cell in the list of candidates is configured in the field cellIndividualOffset of the associated measObject.

According to embodiments of the invention, event A3 is modified as follows (exemplarily shown for the method of FIG. 5; changes underlined):

Event A3 (Neighbour becomes offset better than PCell)

```
The UE shall:
  1> consider the entering condition for this event to be satisfied when
    condition A3-1, as specified below, is fulfilled;
  1> consider the leaving condition for this event to be satisfied when
    condition A3-2, as specified below, is fulfilled;
```

| | |
|---|---|
| NOTE | The cell(s) that triggers the event is on the frequency |
| | indicated in the associated measObject which may be different |
| | from the (primary) frequency used by the PCell. |

Inequality A3-1 (Entering condition)
Mn+Ofn+Ocn−Hys>Mp+Ofp+Ocp+Off
Inequality A3-2 (Leaving condition)
Mn+Ofn+Ocn+Hys<Mp+Ofp+Ocp+Off

The variables in the formula are defined as follows:
Mn is the measurement result of the neighbouring cell, not taking into account any offsets.
Ofn is the frequency specific offset of the frequency of the neighbour cell (i.e. offsetFreq as defined within measObjectEUTRA corresponding to the frequency of the neighbour cell).

Ocn is the cell specific offset of the neighbour cell (i.e. cellIndividualOffset as defined within measObjectEUTRA corresponding to the frequency of the neighbour cell), set to zero if not configured for the neighbour cell, and set to min(cellIndividualOffset of the neighbour cell, cellIndividualOffset of the Pcell+TH) if cellIndividualOffset of the neighbour cell>0, cellIndividualOffset of the PCell>0 and cellIndividualOffset of the PCell<cellIndividualOffset of the neighbour cell
Mp is the measurement result of the PCell, not taking into account any offsets.
Ofp is the frequency specific offset of the primary frequency (i.e. offsetFreq as defined within measObjectEUTRA corresponding to the primary frequency).
Ocp is the cell specific offset of the PCell (i.e. cellIndividualOffset as defined within measObjectEUTRA corresponding to the primary frequency), is set to zero if not configured for the PCell, and set to min(cellIndividualOffset of the PCell, cellIndividualOffset of the neighbour cell+TH) if cellIndividualOffset of the neighbour cell>0, cellIndividualOffset of the PCell>0 and cellIndividualOffset of the PCell>cellIndividualOffset of the neighbour cell.
Hys is the hysteresis parameter for this event (i.e. hysteresis as defined within reportConfigEUTRA for this event).
Off is the offset parameter for this event (i.e. a3-Offset as defined within reportConfigEUTRA for this event).
Mn, Mp are expressed in dBm in case of RSRP, or in dB in case of RS RQ.
TH is the maximum difference between cell specific offsets of the PCell and the neighbour cell
Ofn, Ocn, Ofp, Ocp, Hys, Off, TH are expressed in dB.

Alternatively, embodiments of the invention may be implemented as a new event in addition to event A3.

Embodiments of the invention are described with respect to macro eNB and pica eNB. However, embodiments of the invention may be applied to any kind of base stations where a cell range extension (CRE) is applied. In particular, embodiments of the invention may be applied to homogeneous networks, too.

Embodiments of the invention are described with respect to 3GPP Rel. 10. However, embodiments of the invention may be applied to any radio technology comprising cell selection based on a cell range extension, in particular any other 3GPP release.

Embodiments of the invention are described for two NodeBs which may potentially serve the user equipment. However, in embodiments of the invention, more than two NodeBs may potentially serve the user equipment. In this case, the selection process is performed between the serving cell (in case of handover) or a first candidate cell (in case of cell selection) and each of the candidate cells separately, e.g. in decreasing order of RSRP, according to the above described embodiments of the invention. Embodiments of the invention are described with RSRP as a criterion for cell selection and/or handover. However, other signal strength indicators than RSRP, e.g. RSRQ, may be used instead.

A UE may be a user equipment, a terminal, a mobile phone, a laptop, a smartphone, a tablet PC, or any other device that may attach to the mobile network. A base station may be a NodeB, an eNodeB or any other base station of a radio network.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a user equipment apparatus such as a UE, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. Apparatus, comprising:
at least one processor; and
at least one memory including computer program code, the at least one memory and the computer program code configured, with the at least one processor, to cause the apparatus to perform at least the following:
check if a first received cell range extension received from a first cell is larger than 0;
check if a second received cell range extension received from a second cell is larger than 0, wherein the second cell is different from the first cell;
set, if both the first received cell range extension and the second received cell range extension are larger than 0, a first modified cell range extension based on the first received cell range extension and a second modified cell range extension based on the second received cell range extension, wherein for at least one combination of values of the first and second received cell range extensions at least one of the first and second modified cell range extensions is different from the respective received cell range extension, and
set, if at least one of the first received cell range extension and the second received cell range extension is equal to 0, the first modified cell range extension equal to the first received modified cell range extension and the second modified cell range extension equal to the second received cell range extension;
select one of the first cell and the second cell for cell selection and/or handover based on a comparison of a sum of a first signal strength indicator from the first cell and the first modified cell range extension and a sum of a second signal strength indicator from the second cell and the second modified cell range extension.

2. The apparatus according to claim 1,
and the at least one memory and the computer program code configured, with the at least one processor, to cause the apparatus further to attach the apparatus to the selected cell.

3. The apparatus according to claim 1, wherein the first and second signal strength indicators are respective reference signal received powers or wherein the first and second signal strength indicators are respective reference signal received qualities.

4. The apparatus according to claim 1, and the at least one memory and the computer program code configured, with the at least one processor, to cause the apparatus further to set, if both the first received cell range extension and the second received cell range extension are larger than 0, the first modified cell range extension and the second modified cell range extension such that an absolute value of a difference between the first modified cell range extension and the second modified cell range extension is not larger than a threshold.

5. The apparatus according claim 4,
and the at least one memory and the computer program code configured, with the at least one processor, to cause the apparatus further: to compare which of the first received cell range extension and the second received cell range extension is the larger one;
to set, if the first received cell range extension is not smaller than the second received cell range extension, the first modified cell range extension equal to the minimum among the first received cell range extension and a sum of the second received cell range extension and the threshold, and to set, if the first received cell range extension is smaller than the second received cell range extension, the second modified cell range extension equal to the minimum among the second received cell range extension and a sum of the first received cell range extension and the threshold.

6. The apparatus according to claim 4, wherein the threshold is 0.

7. The apparatus according to claim 1, and the at least one memory and the computer program code configured, with the at least one processor, to cause the apparatus further to set, if both the first received cell range extension and the second received cell range extension are larger than 0, the first modified cell range extension equal to a the first received cell range extension multiplied by a factor and the second modified cell range extension equal to the second received cell range extension multiplied by the factor, wherein the factor is less than 1.

8. User equipment comprising an apparatus according to claim 1.

9. (canceled)

10. Method, comprising
checking if a first received cell range extension received from a first cell is larger than 0;
checking if a second received cell range extension received from a second cell is larger than 0, wherein the second cell is different from the first cell;
setting, if both the first received cell range extension and the second received cell range extension are larger than 0, a first modified cell range extension based on the first received cell range extension and a second modified cell range extension based on the second received cell range extension, wherein for at least one combination of values of the first and second received cell range extensions at least one of the first and second modified cell range extensions is different from the respective received cell range extension,
setting, if at least one of the first received cell range extension and the second received cell range extension is equal to 0, the first modified cell range extension equal to the first received modified cell range extension and the second modified cell range extension equal to the second received cell range extension; and
selecting one of the first cell and the second cell for cell selection and/or handover based on a comparison of a sum of a first signal strength indicator from the first cell and the first modified cell range extension and a sum of a second signal strength indicator from the second cell and the second modified cell range extension.

11. The method according to claim 10, further comprising attaching an apparatus performing the method to the selected cell.

12. The method according to claim 10, wherein the first and second signal strength indicators are respective reference signal received powers or wherein the first and second signal strength indicators are respective reference signal received qualities.

13. The method according to claim 10, wherein, if both the first received cell range extension and the second received cell range extension are larger than 0, the first modified cell range extension and the second modified cell range extension are set such that an absolute value of a difference between the first modified cell range extension and the second modified cell range extension is not larger than a threshold.

14. The method according claim 13, further comprising
comparing which of the first received cell range extension and the second received cell range extension is the larger one; and wherein,
if the first received cell range extension is not smaller than the second received cell range extension, the first modified cell range extension is set equal to the minimum, among the first received cell range extension and a sum of the second received cell range extension and the threshold, and, if the first received cell range extension is smaller than the second received cell range extension, the second modified cell range extension is set equal to the minimum among the second received cell range extension and a sum of the first received cell range extension and the threshold.

15. The method according to claim 13, wherein the threshold is 0.

16. The method according to claim 10, wherein, if both the first received cell range extension and the second received cell range extension are larger than 0, the first modified cell range extension is set equal to a the first received cell range extension multiplied by a factor and the second modified cell range extension is set equal to the second received cell range extension multiplied by the factor, wherein the factor is less than 1.

17. A computer program product comprising a non-transitory computer-readable storage medium bearing computer program code embodied therein for use with a computer, the computer program code comprising code for performing the method of claim 10.

18. (canceled)
